(19) United States
(12) Patent Application Publication
(10) Pub. No.: US 2022/0352581 A1
(43) Pub. Date: Nov. 3, 2022

(54) SECONDARY BATTERY AND METHOD OF MANUFACTURING THE SAME

(71) Applicant: Murata Manufacturing Co., Ltd., Nagaokakyo-shi (JP)

(72) Inventor: Kenta EGUCHI, Nagaokakyo-shi (JP)

(21) Appl. No.: 17/867,723

(22) Filed: Jul. 19, 2022

Related U.S. Application Data
(63) Continuation of application No. PCT/JP2021/001499, filed on Jan. 18, 2021.

(30) Foreign Application Priority Data
Jan. 20, 2020 (JP) 2020-006868

(51) Int. Cl. H01M 50/171; H01M 50/103; H01M 50/119

(52) U.S. Cl. CPC H01M 50/171; H01M 50/103; H01M 50/119

(57) ABSTRACT

A method of manufacturing a secondary battery that includes combining a first metal casing and a second metal casing with each other without being crimped so as to house an electrode assembly between the first metal casing and the second metal casing. Also disclosed is a secondary battery that includes: an electrode assembly; a first metal casing; and a second metal casing, wherein the first metal casing and the second metal casing are combined with each other without being crimped so as to house the electrode assembly between the first metal casing and the second metal casing.

### CROSS REFERENCE TO RELATED APPLICATIONS

The present application is a continuation of International application No. PCT/JP2021/001499, filed Jan. 18, 2021, which claims priority to Japanese Patent Application No. 2020-006868, filed Jan. 20, 2020, the entire contents of each of which are incorporated herein by reference.

### FIELD OF THE INVENTION

The present invention relates to a secondary battery and a method of manufacturing the same. In particular, the present invention relates to a method of manufacturing a secondary battery provided with an electrode assembly including an electrode constituting layer including a positive electrode, a negative electrode and a separator, and also relates to a secondary battery obtained by the manufacturing method.

### BACKGROUND OF THE INVENTION

Secondary batteries are so-called storage batteries and therefore can be repeatedly charged and discharged, and the secondary batteries are used in various applications. For example, secondary batteries are used for mobile devices such as mobile phones, smart phones and notebook computers.
Patent Document 1: Japanese Patent Application Laid-Open (Translation of PCT Application) No. 2015-536036
Patent Document 2: Japanese Patent Application Laid-Open (Translation of PCT Application) No. 2012-523067

### SUMMARY OF THE INVENTION

The inventor of the present invention noticed that there were problems to be overcome with respect to conventional secondary batteries, and found need to take measures therefor. Specifically, the inventor of the present invention found that there were the following problems.

A secondary battery includes an electrode assembly in which electrode constituting layers each including a positive electrode, a negative electrode, and a separator therebetween are stacked, and a casing that encloses the electrode assembly.

A metal casing of the secondary battery includes, for example, two metal members, and has a crimping structure. That is, an external force is applied to the two metal members constituting the casing to plastically deform the metal members, and the electrode assembly is wrapped and sealed with the metal members thus deformed.

The crimping structure is based on the premise that the casing is deformed. Thus, the size of the casing increases as a whole due to the deformation in the crimping structure. Specifically, as illustrated in FIGS. 14 and 15, the crimping structure is plastically deformed, and a width dimension of the casing increases due to such deformation. Thus, the crimping structure of the casing is not necessarily desirable in terms of a volume energy density of the battery and the like.

The present invention has been made in view of the above problems. That is, a main object of the present invention is to provide a new battery technology in terms of a casing configuration.

Rather than addressing as merely extensions of conventional arts, the inventor of the present invention tried to solve the above problems by addressing from a new point of view. As a result, the inventor has created “the invention of a method of manufacturing a secondary battery” and “the invention of a secondary battery”, both of which are capable of achieving the above main object.

A manufacturing method according to the present invention is a method of manufacturing a secondary battery including an electrode assembly and a casing that houses the electrode assembly, the method including forming the casing by combining a first metal casing and a second metal casing, which are metal members, with each other without crimping.

A secondary battery according to the present invention is a secondary battery including an electrode assembly and a casing that houses the electrode assembly, in which the casing has a two-part configuration including a first metal casing and a second metal casing, and the first metal casing and the second metal casing, which are metal members, are combined with each other without being crimped.

In the secondary battery according to the present invention, the casing is not crimped, and a dimensional increase due to plastic deformation of the casing is avoided. That is, the casing according to the present invention can suitably contribute to the improvement of the volume energy density of the battery.

Since a conventional crimping involves deformation of the casing due to application of an external force, the casing is affected to a considerable extent in terms of material due to a deformation history. On the other hand, in the present invention, since the casing is configured without being deformed, it is possible to provide an advantage that the casing easily has long-term stability in terms of its material as compared with a conventional battery having a crimping structure.

### BRIEF EXPLANATION OF THE DRAWINGS

FIGS. 1(A) and 1(B) are sectional views schematically illustrating a configuration of an electrode assembly, where FIG. 1(A) is a non-wound planar lamination type, and FIG. 1(B) is a wound type.

FIG. 2 is a schematic sectional view showing a concept of a manufacturing method of the present invention according to an embodiment.

FIG. 3 is a perspective view schematically illustrating a cup-shaped form of a first metal casing and a second metal casing.

FIG. 4 is a schematic sectional view showing a concept of a manufacturing method of the present invention according to another embodiment.

FIG. 5 is a perspective view schematically illustrating an exemplary embodiment of a button type or coin type secondary battery.

FIG. 6 is a schematic sectional view for explaining an embodiment related to a “folded mode of a current collection tab assembly”.

FIG. 7 is a schematic sectional view for explaining another embodiment related to a “folded mode of a current collection tab assembly”.

FIG. 8 is a schematic sectional view for explaining an aspect in which a conductive member is provided.

FIGS. 9(A) and 9(B) are schematic perspective views for explaining a feature related to a size of a conductive member disposed on a main surface of an electrode assembly, where FIG. 9(A) is one embodiment of the present invention, and FIG. 9(B) is a comparative technique.

FIG. 10 is a schematic sectional view for explaining an aspect in which a current collection tab assembly and the casing are welded to each other.

FIG. 11 is a schematic sectional view for explaining a non-crimping characteristic of the casing in the secondary battery of the present invention.

FIG. 12 is a schematic sectional view for explaining the non-crimping characteristic (welding characteristic) of the casing in the secondary battery of the present invention.

FIG. 13 is a perspective view schematically illustrating an exemplary embodiment of a rectangular secondary battery.

FIG. 14 is a schematic sectional view for explaining the casing having a conventional crimping structure (conventional art).

FIG. 15 is a schematic sectional view for explaining the casing having the conventional crimping structure (conventional art).

### DETAILED DESCRIPTION OF THE INVENTION

Hereinafter, a secondary battery according to an embodiment of the present invention will be described in more detail. Although description will be made with reference to the drawings as necessary, various elements are schematically and exemplarily shown in the drawings wherein their appearances and/or their dimensional proportions and the like are not necessarily real ones, and are merely for the purpose of making it easy to understand the present invention.

A “sectional view”, which is directly or indirectly used herein, is one based on a virtual section obtained by cutting the secondary battery along a stacking direction of the electrode assembly or the electrode constituting layer constituting the secondary battery. Similarly, the direction of “thickness”, which is directly or indirectly used herein, is one based on the stacking direction of electrode materials constituting the secondary battery. For example, in the case of “a secondary battery having a thickness in a plate shape” such as a button type or a coin type, a direction of “thickness” corresponds to a thickness direction of the secondary battery. A thickness of a side wall of the casing and a thickness of an insulating bonding material used for the side wall correspond to a thickness in a direction orthogonal to the stacking direction. The term “planar view” used here is one based on a sketch of an object when the object is viewed from above or below along a thickness direction based on the stacking direction.

The terms “vertical direction” and “horizontal direction” directly or indirectly used here correspond respectively to the vertical direction and the horizontal direction in the drawing. Unless otherwise stated, the same numerals or symbols denote the same members or portions or the same contents. In a preferred embodiment, while the stacking direction of the electrode assembly can correspond to the vertical direction, it can be grasped that a vertical downward direction (that is, a direction in which gravity acts) corresponds to a “downward direction”, and the opposite direction corresponds to an “upward direction”.

[Basic Configuration of Secondary Battery]

The term “secondary battery” used here refers to a battery that can be repeatedly charged and discharged. Therefore, the secondary battery according to the present invention is not excessively limited by its name, and, for example, an electric storage device and the like are also included in the subject of the present invention.

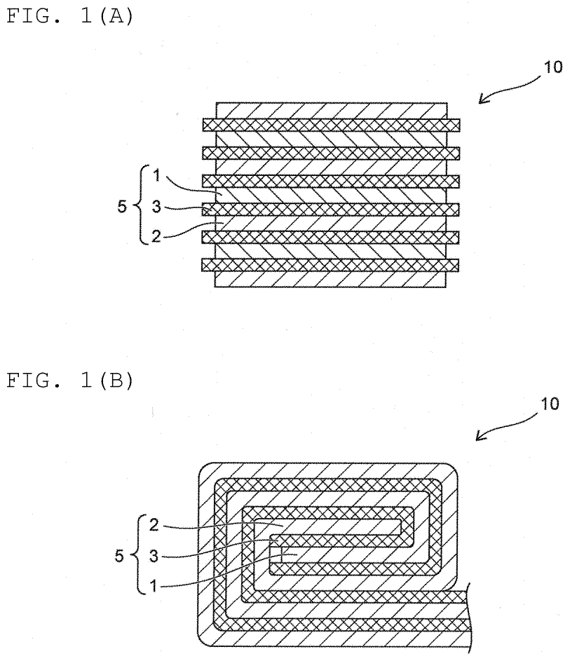

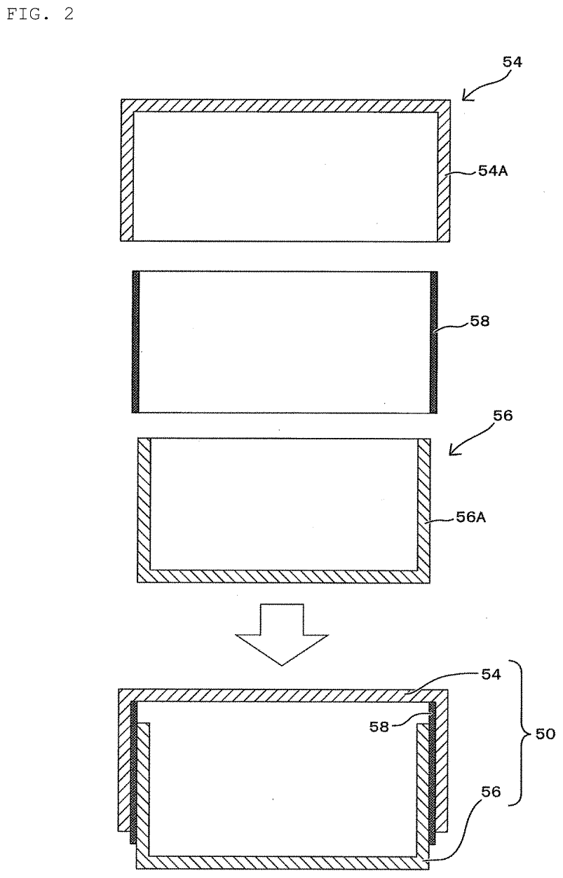

The secondary battery according to the present invention includes an electrode assembly in which an electrode constituting layer including a positive electrode, a negative electrode and a separator is stacked. FIG. 1 shows an electrode assembly 10. As illustrated, a positive electrode 1 and a negative electrode 2 overlap each other with a separator 3 interposed therebetween to form an electrode constituting layer 5, and at least one or more of the electrode constituting layers 5 are stacked to form the electrode assembly 10. In the secondary battery, such an electrode assembly is enclosed in a casing together with an electrolyte (for example, a nonaqueous electrolyte). A structure of the electrode assembly is not necessarily limited to a planar stacking structure (see FIG. 1(A)), and may have, for example, a winding structure (see FIG. 1(B)) in which an electrode unit (electrode constituting layer) including a positive electrode, a negative electrode, and a separator disposed between the positive electrode and the negative electrode is wound in a roll shape. That is, for example, as illustrated in FIG. 1(A), the electrode assembly 10 may have a configuration in which the electrode constituting layers 5 are stacked so as to be stacked on each other. Alternatively, the electrode assembly 10 may have the winding structure in which the electrode constituting layer 5 extending relatively long in a band shape is wound in a roll shape, for example, as illustrated in FIG. 1(B). In addition, the electrode assembly may have, for example, a so-called stack-and-folding type structure in which the positive electrode, the separator, and the negative electrode are stacked on a long film and then folded.

The positive electrode is constituted of at least a positive electrode material layer and a positive electrode current collector. In the positive electrode, the positive electrode material layer is provided on at least one side of the positive electrode current collector, and the positive electrode material layer contains a positive electrode active material as an electrode active material. For example, in each of a plurality of the positive electrodes in the electrode assembly, the positive electrode material layers may be provided on both sides of the positive electrode current collector, or the positive electrode material layer may be provided only on one side of the positive electrode current collector.

The negative electrode is constituted of at least a negative electrode material layer and a negative electrode current collector. In the negative electrode, the negative electrode material layer is provided on at least one side of the negative electrode current collector, and the negative electrode material layer contains a negative electrode active material as an electrode active material. For example, in each of a plurality of the negative electrodes in the electrode assembly, the negative electrode material layers may be provided on both sides of the negative electrode current collector, or the negative electrode material layer may be provided only on one side of the negative electrode current collector.

The electrode active materials contained in the positive and negative electrodes, that is, the positive electrode active material and the negative electrode active material are substances directly involved in the transfer of electrons in the secondary battery and are main substances of the positive and negative electrodes which are responsible for charging and discharging, namely a battery reaction. More specifically, ions are generated in the electrolyte by “the positive electrode active material contained in the positive electrode material layer” and “the negative electrode active material contained in the negative electrode material layer”, and the ions move between the positive electrode and the negative electrode and the electrons are transferred, whereby charging and discharging are performed. The positive electrode material layer and the negative electrode material layer particularly may be layers capable of inserting and extracting a lithium ion. In other words, the secondary battery according to the present invention may be a nonaqueous electrolyte secondary battery in which a lithium ion moves between the positive electrode and the negative electrode through a nonaqueous electrolyte, thereby charging and discharging the battery. When lithium ions are involved in charging and discharging, the secondary battery according to the present invention corresponds to a so-called “lithium ion battery”, and the positive electrode and the negative electrode have a layer capable of inserting and extracting a lithium ion.

The positive electrode active material of the positive electrode material layer is composed of, for example, a granular material, and a binder may be contained in the positive electrode material layer in order to maintain a more sufficient contact between particles and the shape of the particles. Further, a conductive auxiliary agent may be contained in the positive electrode material layer in order to facilitate transmission of electrons promoting the battery reaction. Similarly, when the negative electrode active material of the negative electrode material layer is composed of, for example, a granular material, a binder may be contained in order to maintain a more sufficient contact between particles and the shape of the particles, and a conductive auxiliary agent may be contained in the negative electrode material layer in order to facilitate transmission of electrons promoting the battery reaction. As described above, since a plurality of components is contained, the positive electrode material layer and the negative electrode material layer can also be referred to as “positive electrode mixture layer” and “negative electrode mixture layer”, respectively.

The positive electrode active material may be a substance that contributes to insertion and extraction of a lithium ion. In this respect, the positive electrode active material may be, for example, a lithium-containing composite oxide. More specifically, the positive electrode active material may be a lithium-transition metal composite oxide containing lithium and at least one transition metal selected from the group consisting of cobalt, nickel, manganese, and iron. That is, the positive electrode material layer of the secondary battery according to the present invention preferably contains such a lithium-transition metal composite oxide as a positive electrode active material. Examples of the positive electrode active material may include lithium cobaltate, lithium nickelate, lithium manganate, lithium iron phosphate, or materials in which a part of the transition metal of these is substituted with another metal. Such a positive electrode active material may be contained singly or in combination of two or more.

The binder which can be contained in the positive electrode material layer is not particularly limited, but examples thereof include at least one selected from the group consisting of polyvinylidene fluoride, a vinylidene fluoride-hexafluoropropylene copolymer, a vinylidene fluoride-tetrafluoroethylene copolymer, polytetrafluoroethylene and the like. The conductive auxiliary agent which can be contained in the positive electrode material layer is not particularly limited, but examples thereof include at least one selected from the group consisting of carbon black such as thermal black, furnace black, channel black, ketjen black, and acetylene black; carbon fibers such as graphite, carbon nanotube, and vapor-grown carbon fiber; metal powders such as copper, nickel, aluminum, and silver; polyphenylene derivatives, and the like.

A thickness dimension of the positive electrode material layer is not particularly limited, and may be 1 μm to 300 μm, and is, for example, 5 μm to 200 μm. The thickness dimension of the positive electrode material layer is a thickness inside the secondary battery, and an average value of measured values at arbitrary ten points may be adopted.

The negative electrode active material may be a substance that contributes to insertion and extraction of a lithium ion. In this respect, the negative electrode active material may be, for example, various carbon materials, oxides and/or lithium alloys.

Examples of various carbon materials of the negative electrode active material include graphite (natural graphite, artificial graphite), hard carbon, soft carbon, and diamond-like carbon. In particular, graphite has high electron conductivity and excellent adhesive properties to the negative electrode current collector. Examples of the oxide of the negative electrode active material include at least one selected from the group consisting of silicon oxide, tin oxide, indium oxide, zinc oxide, lithium oxide and the like. The lithium alloy of the negative electrode active material may be any metal as long as the metal can be alloyed with lithium, and the lithium alloy may be, for example a binary, ternary or higher alloy of a metal such as Al, Si, Pb, Sn, In, Bi, Ag, Ba, Ca, Hg, Pd, Pt, Te, Zn or La and lithium. Such an oxide may be amorphous as its structural form. This is because degradation due to nonuniformity such as crystal grain boundaries or defects is hardly caused.

The binder which can be contained in the negative electrode material layer is not particularly limited, but examples thereof include at least one kind selected from the group consisting of styrene-butadiene rubber, polyacrylic acid, polyvinylidene fluoride, polyimide-based resin, and polyamideimide-based resin. The conductive auxiliary agent which can be contained in the negative electrode material layer is not particularly limited, but examples thereof include at least one selected from the group consisting of carbon black such as thermal black, furnace black, channel black, ketjen black, and acetylene black; carbon fibers such as graphite, carbon nanotube, and vapor-grown carbon fiber; metal powders such as copper, nickel, aluminum, and silver; polyphenylene derivatives, and the like. It is to be noted that the negative electrode material layer may contain a component caused by a thickener component (for example, carboxymethyl cellulose) used at the time of manufacturing the battery.

The thickness dimension of the negative electrode material layer is not particularly limited, and may be 1 μm to 300 μm, and is, for example, 5 μm to 200 μm. The thickness dimension of the negative electrode material layer is the thickness inside the secondary battery, and an average value of measured values at arbitrary ten points may be adopted.

The positive electrode current collector and the negative electrode current collector used for the positive electrode and the negative electrode are members that contribute to the collection and supply of electrons generated in the electrode active material by the battery reaction. Such an electrode current collector may be a sheet-like metal member. Furthermore, such an electrode current collector may have a porous or perforated form. For example, each of the current collectors may be a metal foil, a punching metal, a net, an expanded metal, or the like. The positive electrode current collector used for the positive electrode is preferably made of a metal foil containing at least one selected from the group consisting of aluminum, stainless steel, nickel and the like, and may be, for example, an aluminum foil. On the other hand, the negative electrode current collector used for the negative electrode is preferably made of a metal foil containing at least one selected from the group consisting of copper, stainless steel, nickel and the like, and may be, for example, a copper foil.

The thickness dimensions of the positive electrode current collector and the negative electrode current collector are not particularly limited, and may be 1 μm to 100 μm, and is, for example, 10 μm to 70 μm. The thickness dimensions of the positive electrode current collector and the negative electrode current collector correspond to the thickness inside the secondary battery, and an average value of measured values at arbitrary ten points may be adopted.

The separator used for the positive electrode and the negative electrode is a member provided from the viewpoints of the prevention of a short circuit due to contact between the positive and negative electrodes and the holding of the electrolyte and the like. In other words, it can be said that the separator is a member that passes ions while preventing electronic contact between the positive electrode and the negative electrode. For example, the separator is a porous or microporous insulating member and may have a film form due to its small thickness. Although it is merely an example, a microporous membrane made of polyolefin may be used as the separator. In this respect, the microporous membrane used as the separator may contain, for example, only polyethylene (PE) or only polyethylene (PP) as polyolefin Further, the separator may be a laminate including “a microporous membrane made of PE” and “a microporous membrane made of PP”. The surface of the separator may be covered with an inorganic particle coating layer, and/or an adhesive layer. The surface of the separator may have adhesive properties. In the present invention, the separator should not be particularly restricted by its name, and may be a solid electrolyte, a gel-like electrolyte, and/or an insulating inorganic particle, or the like that has a similar function.

The thickness dimension of the separator is not particularly limited, and may be 1 μm to 100 μm, and is, for example, 2 μm to 20 μm. The thickness dimension of the separator is the thickness inside the secondary battery (particularly, thickness between the positive electrode and the negative electrode), and an average value of measured values at arbitrary ten points may be adopted.

In the secondary battery according to the present invention, the electrode assembly composed of the electrode constituting layer including the positive electrode, the negative electrode, and the separator may be enclosed in the casing together with an electrolyte. The electrolyte can assist movement of metal ions released from the electrodes (positive electrode and/or negative electrode). The electrolyte may be a “nonaqueous” electrolyte, such as an organic electrolyte and an organic solvent, or may be an “aqueous” electrolyte containing water. When the positive electrode and the negative electrode have a layer capable of inserting and extracting a lithium ion, the electrolyte is preferably a “nonaqueous” electrolyte including an organic electrolyte, an organic solvent, and the like. That is, the electrolyte preferably serves as a nonaqueous electrolyte. In the electrolyte, metal ions released from the electrode (positive electrode and/or negative electrode) will be present, and the electrolyte will thus help the movement of the metal ions in the battery reaction. The electrolyte may have a form such as a liquid form or a gel form.

The nonaqueous electrolyte is an electrolyte containing a solvent and a solute. A specific solvent for the nonaqueous electrolyte may contain at least a carbonate. The carbonates may be cyclic carbonates and/or chain carbonates. Although not particularly limited, examples of the cyclic carbonates include at least one kind selected from the group consisting of propylene carbonate (PC), ethylene carbonate (EC), butylene carbonate (BC), and vinylene carbonate (VC). Examples of the chain carbonates include at least one kind selected from the group consisting of dimethyl carbonate (DMC), diethyl carbonate (DEC), ethyl methyl carbonate (EMC), and dipropyl carbonate (DPC). Although it is merely an example, a combination of cyclic carbonate and chain carbonate may be used as the nonaqueous electrolyte, and, for example, a mixture of ethylene carbonate and diethyl carbonate may be used. As a solute of a specific nonaqueous electrolyte, for example, an Li salt such as LiPF₆ and/or LiBF₄ may be used.

The casing of the secondary battery is a member enclosing the electrode assembly in which the electrode constituting layer including the positive electrode, the negative electrode and the separator is stacked. As will be described later, in the present invention, the casing is preferably a metal casing having a non-laminate configuration.

[Features of Manufacturing Method of the Present Invention]

The present invention is characterized by a configuration of the casing of the secondary battery. The secondary battery has a feature in terms of a configuration of a member capable of housing or enclosing the electrode assembly. Specifically, in the manufacturing method of the present invention, in the casing, a first metal casing and a second metal casing, which are metal members, are combined with each other without being crimped.

In the manufacturing method of the present invention, a metal casing is used as the casing. The metal casing preferably has a non-laminate configuration. That is, preferably, the casing does not have a laminate configuration as a whole. Thus, in the present invention, the first metal casing and the second metal casing do not have a stacking structure, and do not serve as, for example, a laminate member of a metal sheet/a fusion layer/a protective layer. It can be said that the metal casing in the present invention is different from a casing of a soft case type battery corresponding to a pouch formed of a so-called laminate film. While the laminate configuration usually includes a resin layer, the metal casing having the non-laminate configuration does not include such a resin layer. Preferably, the first metal casing and the second metal casing are formed of a metal single member. For example, each of the first metal casing and the second metal casing may be a single member made of metal such as stainless steel (SUS) or aluminum. The term “metal single member” as used herein means that the casing does not have a so-called laminate configuration in a broad sense, and means that each of the first metal casing and the second metal casing is a member substantially composed only of metal in a narrow sense. Therefore, when the member substantially composed only of metal is used, an appropriate surface treatment may be performed on a surface of the metal casing. For example, on a cut surface obtained by cutting such a metal casing in the thickness direction thereof, a single metal layer can be confirmed except for a portion subjected to surface treatment or the like. The term “stainless steel” in the present specification refers to, for example, stainless steel defined in “JIS G0203 Terms used in iron and steel”, and may be chromium or alloy steel containing chromium and nickel.

Each of the first metal casing and the second metal casing used in the manufacturing method of the present invention may have a relatively thin thickness as a metal member (particularly, metal single member). For example, each of the first metal casing and the second metal casing in the present invention may have a thickness dimension of 50 μm to less than 200 μm, and, for example, the thickness dimension may be 50 μm to 190 μm, 50 μm to 180 μm, 50 μm to 170 μm, or other value.

In the manufacturing method of the present invention, while the first metal casing and the second metal casing which are such metal members are combined with each other to obtain an exterior body, crimping treatment is not performed. That is, the first metal casing and the second metal casing may be combined in a state where such a large external force that deforms at least one of the first metal casing and the second metal casing is not applied and these forms are substantially maintained.

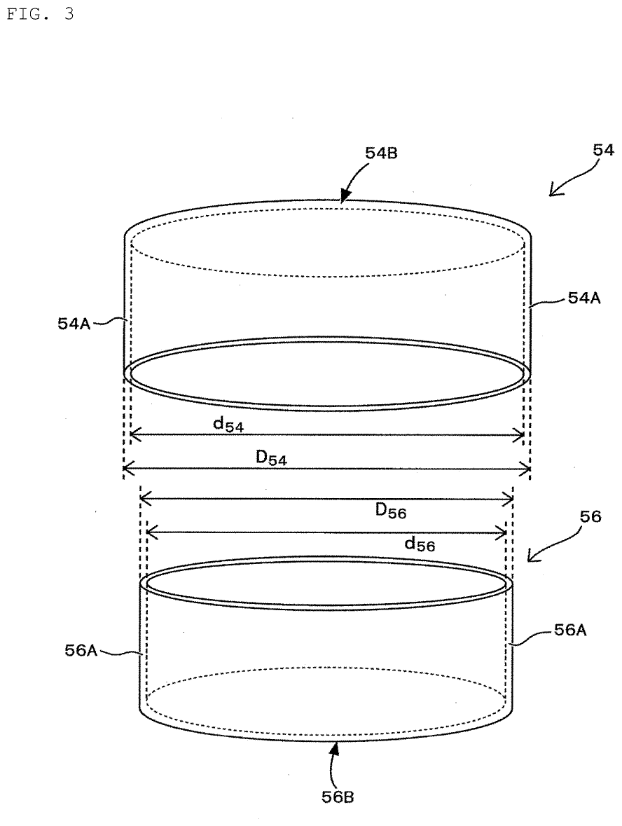

FIG. 2 schematically illustrates a concept of the manufacturing method of the present invention. As shown in the drawing, a casing 50 is constituted of a first metal casing 54 and a second metal casing 56. That is, the casing 50 may have a two-part configuration including the first metal casing 54 and the second metal casing 56.

In the present invention, the first metal casing and the second metal casing may have the same form. The term “the same form” as used herein means that the first metal casing and the second metal casing have the same form as each other in a macroscopic view. For example, in the first metal casing and the second metal casing according to the same form as described above, if the first metal casing and the second metal casing are different from each other in terms of the width dimension, the height dimension and/or the thickness dimension and the like (for example, if there is a slight difference with a difference of less than 40%, less than 30%, less than 20% or less than 10% for at least one of their dimensions), the overall shapes are the same.

Although it is merely one example, as shown in FIG. 3, each of the first metal casing 54 and the second metal casing 56 may be a cup-shaped member. That is, the casing may be constituted of at least the first metal casing 54 as the cup-shaped member and the second metal casing 56 as the cup-shaped member. The term “cup-shaped member” used here is a member including a side wall or a side surface portion corresponding to a body portion and a main surface portion (in a typical aspect, for example, a bottom portion) continuous with the side wall or the side surface portion, in which a hollow portion is formed inside.

In the manufacturing method of the present invention, the casing 50 is obtained by combining the first metal casing 54 and the second metal casing 56, and preferably, when the first metal casing and the second metal casing are combined, processing of reducing the width dimensions of the metal casings in part or as a whole is not performed. That is, the first metal casing 54 and the second metal casing 56 may be combined with each other while the width dimension of each of the first metal casing 54 and the second metal casing 56 is maintained as it is. Specifically, when the first metal casing 54 and the second metal casing 56 are combined, an outer diameter D₅₄ and an inner diameter d₅₄ of the first metal casing 54 may be maintained as they are, and an outer diameter D₅₆ and an inner diameter d₅₆ of the second metal casing 56 may also be maintained as they are. That is, the first metal casing 54 having the predetermined outer diameter D₅₄ and inner diameter d₅₄ before the combination may be used while maintaining such outer diameter and inner diameter at the time of the combination, and the second metal casing 56 having the predetermined outer diameter D₅₆ and inner diameter d₅₆ before the combination may also be used while maintaining such outer diameter and inner diameter at the time of the combination. That is, in the present invention, the first metal casing and the second metal casing may be provided to have a predetermined or desired form in advance before the electrode assembly is housed or enclosed in the casing; however, the forms of the first metal casing and the second metal casing as described above may be used without being substantially changed before and after the electrode assembly is stored or enclosed in the casing. As can be seen from such an exemplary description, in the present invention, the first metal casing and the second metal casing are not crimped when they are combined with each other, and portions corresponding to the side walls of both the first metal casing and the second metal casing are not substantially subjected to deformation due to crimping in the combining step.

In the present specification, the term “crimping” means, in a broad sense, combining metal members forming the casing by using plastic deformation of the metal member. In a narrow sense, “crimping” in the present specification means that a portion (for example, portion which forms a casing side wall which determines a width size of the casing) of the metal member provided for combination of the casing is plastically deformed in part or as a whole to connect the metal members to each other.

Therefore, in the present invention, the expression that “without crimping” means, in a broad sense, that when the first metal casing and the second metal casing are combined with each other, plastic deformation of at least one of the first metal casing and the second metal casing (for example, plastic deformation in which both metal casings are deformed) is not used. Typically, in the present invention, the expression that “without crimping” substantially means that the casing is obtained by combining the first metal casing and the second metal casing without plastically deforming a metal wall portion, corresponding to the side wall of the casing, in part or as a whole.

In the manufacturing method of the present invention, as shown in FIG. 2, in each of the first metal casing 54 and the second metal casing 56, the first metal casing 54 and the second metal casing 56 are combined with each other without changing the width dimension thereof (particularly without changing the width dimension in part or as a whole). For example, the first metal casing and the second metal casing are combined so that side walls of the first metal casing and the second metal casing are aligned with each other. More specifically, when the first metal casing and the second metal casing are combined, the side wall of the first metal casing and the side wall of the second metal casing face each other without changing their forms locally or in part. That is, local or partial deformation corresponding to crimping deformation is not applied to the portion corresponding to the side wall of each of the first metal casing and the second metal casing when the first metal casing and the second metal casing are combined.

By such a combination of side walls, it is possible to obtain a battery in which entrance of moisture is more suitably prevented. That is, when the side wall portions are joined to form a joint surface, a passing distance further increases when external moisture enters the inside of the casing via the insulating bonding material (see the “insulating bonding material” described later). Thus, moisture in a surrounding environment is unlikely to enter the inside of the casing, and the secondary battery is likely to be suitable from the viewpoint of preventing moisture from being mixed despite non-crimping. Here, when a side wall portion 54A of the first metal casing 54 and a side wall portion 56A of the second metal casing 56 are aligned so as to face each other to constitute the side wall of the metal casing 56, the form of the side wall portion 54A of the first metal casing 54 may be maintained as an initial form at any portion of the side wall portion, and similarly, the second metal casing 56 may be maintained as an initial form at any portion of the side wall portion 56B. For example, the first metal casing 54 and the second metal casing 56 may be fitted to each other in a state where an initial shape is substantially maintained as it is, and thus, the casing may be configured.

As described above, in the present invention, since the casing is configured without crimping, the width dimension of the casing does not increase due to the deformation of the casing, and a volume energy density of the battery can be improved. As described above, considering that the side walls of the first metal casing and the second metal casing are aligned to each other, not only the volume energy density of the battery can be improved, but also moisture can be prevented from being mixed, so that a secondary battery suitable for both of these points can be provided.

In a preferred aspect, both the first metal casing 54 and the second metal casing 56 may be cup-shaped members (see FIG. 3). That is, the first metal casing 54 and the second metal casing 56 preferably include the main surface portions 54B and 56B and the side wall portions 54A and 56A extending substantially perpendicularly to the main surface portions, respectively. In this regard, it is preferable that one of the first metal casing and the second metal casing corresponds to an inner cup, and the other of the first metal casing and the second metal casing corresponds to an outer cup. This is because the casing can be configured such that the first metal casing and the second metal casing are fitted to each other. In the illustrated aspect, the first metal casing 54 corresponds to the outer cup, and the second metal casing 56 corresponds to the inner cup. The first metal casing 54 corresponding to the outer cup and the second metal casing 56 corresponding to the inner cup may be combined without changing the forms of the portions, corresponding to the side walls thereof, locally or in part. In order to suitably fit the first metal casing and the second metal casing to each other, the inner diameter of the first metal casing 54 as the outer cup and the outer diameter of the second metal casing 56 as the inner cup may have substantially the same dimension, or may have different dimensions by the thickness of the insulating bonding material described later. In this way, since the first metal casing 54 and the second metal casing 56 are combined by “non-crimping” before and after the combination, an instrument for crimping is not required in the present invention, and the casing can be relatively easily formed.

In the manufacturing method of the present invention, when the first metal casing and the second metal casing are combined, plastic deformation for crimping is not used. Preferably, a portion provided for the combining the first metal casing and the second metal casing is not bent or recessed, and constitutes the casing. The portion provided for the combining may be a portion corresponding to the side wall of each of the first metal casing and the second metal casing. That is, the first metal casing and the second metal casing may be combined such that the side wall of the first metal casing and the side wall of the second metal casing are joined to each other or overlapped with each other at least in part, and at that time, both the side wall of the first metal casing and the side wall of the second metal casing are not crimped. This means that both the side wall of the first metal casing and the side wall of the second metal casing are not locally deformed by an external force. It can also be said that the portions corresponding to the side walls of both the first metal casing and the second metal casing do not change their forms locally or in part before and after the combining the first metal casing and the second metal casing. In other words, in the first metal casing and the second metal casing, the first metal casing and the second metal casing are combined without bending or recessing the portions provided for joint. As described above, since the casing is configured without crimping, the width dimension of the casing does not increase due to the deformation of the casing, and the volume energy density of the battery can be improved. Since the casing is configured without locally plastically deforming the first metal casing and the second metal casing, there is no deformation history, and there is also an advantage that the casing easily has long-term stability in terms of its material.

In the manufacturing method of the present invention, the insulating bonding material may be used for the configuration of the casing. As shown in FIG. 2, the first metal casing 54 and the second metal casing 56 may be joined to each other by an insulating bonding material 58 disposed between the side wall 54A of the first metal casing 54 and the side wall 56A of the second metal casing 56. That is, the casing may be obtained by connecting the side walls of the first metal casing and the second metal casing to each other with the insulating bonding material interposed therebetween. Since crimping is not performed, the first metal casing and the second metal casing maintain substantially the initial form as it is before and after the combination.

As shown in a sectional view of FIG. 2, while the entire portion of the side wall 54A of the first metal casing 54 extends linearly, the entire portion of the side wall 56A of the second metal casing 56 also extends linearly, and the insulating bonding material 58 extending linearly in the sectional view may be provided so as to be sandwiched between such linear side walls. In the illustrated sectional view, the insulating bonding material 58 linearly extends along the side wall (in particular, the main surfaces of the side walls 54A and 56A) and/or parallel to the side wall without changing the thickness thereof. It can also be said that the insulating bonding material 58 in the form of non-bending/non-recess is provided so as to be sandwiched between the side wall 54A of the first metal casing 54 in the form of non-bending/non-recess and the side wall 56A of the second metal casing 56 in the form of non-bending/non-recess.

The insulating bonding material may be preformed, and may be, for example, a sheet-like member (preferably a flexible sheet-like member). Alternatively, the insulating bonding material may be obtained by applying a paste-like raw material to the casing. The material of such an insulating bonding material is not particularly limited as long as it exhibits “insulating properties” and “bonding properties”. For example, the insulating bonding material may contain a thermoplastic resin. Although only a specific example, the insulating bonding material may include polyolefins such as polyethylene and/or polypropylene. In other words, the insulating bonding material may contain a component of an insulating adhesive. Examples of such an adhesive include an acrylic adhesive such as an acrylic acid ester copolymer, a rubber adhesive such as natural rubber, a silicone adhesive such as silicone rubber, a urethane adhesive such as urethane resin, an α-olefin adhesive, an ether adhesive, an ethylene-vinyl acetate resin adhesive, an epoxy resin adhesive, a vinyl chloride resin adhesive, a chloroprene rubber adhesive, a cyanoacrylate adhesive, an aqueous polymer-isocyanate adhesive, a styrene-butadiene rubber adhesive, a nitrile rubber adhesive, a nitrocellulose adhesive, a reactive hot-melt adhesive, a phenol resin adhesive, a modified silicone adhesive, a polyamide resin adhesive, a polyimide adhesive, a polyurethane resin adhesive, a polyolefin resin adhesive, a polyvinyl acetate resin adhesive, a polystyrene resin solvent adhesive, a polyvinyl alcohol-based adhesive, a polyvinyl pyrrolidone resin adhesive, a polyvinyl butyral resin-based adhesive, a polybenzimidazole-based adhesive, a polymethacrylate resin-based adhesive, a melamine resin-based adhesive, a urea resin-based adhesive, and a resorcinol-based adhesive.

In the manufacturing method of the present invention, when the insulating bonding material is interposed between the first metal casing and the second metal casing, a portion provided for the combining the first metal casing and the second metal casing is not subjected to crimping deformation. Thus, it is possible to improve the volume energy density of the secondary battery without increasing the width dimension of the casing by the amount that there is no deformation due to crimping.

In the first place, the insulating bonding material is a thin member. For example, the thickness of the insulating bonding material may be smaller than the thickness of each of the first metal casing and the second metal casing. In the present invention, since the crimping treatment is not performed, local deformation or the like of the insulating bonding material is reduced. For example, when the first metal casing and the second metal casing are combined with each other, the insulating member is not bent or recessed, and the form of the insulating bonding material is substantially maintained as it is. Since the insulating bonding material is not locally deformed as described above, the volume energy density can be improved as the secondary battery without increasing the width dimension of the casing accordingly. Since the insulating bonding material is not also deformed, there is no deformation history, and there is an advantage that the insulating bonding material easily has long-term stability in terms of its material quality.

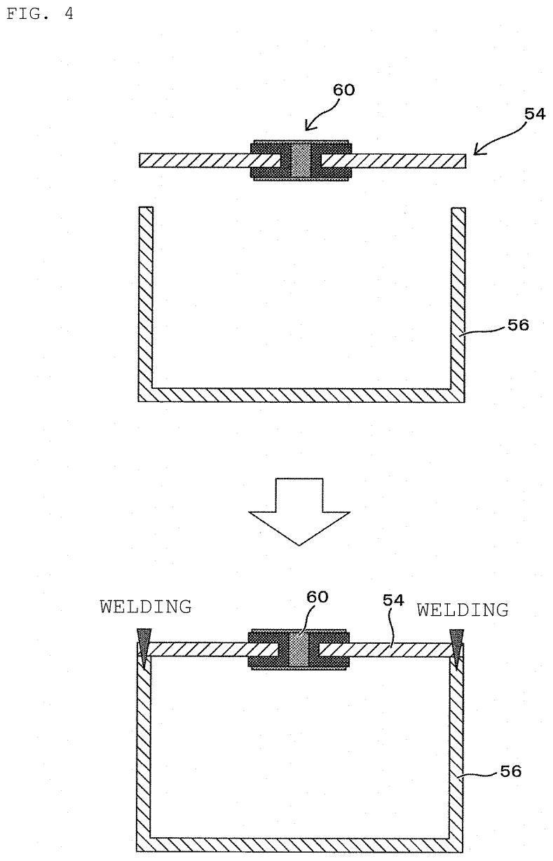

In the manufacturing method of the present invention, heat treatment may be used in the configuration of the casing. For example, welding may be used in the configuration of the casing. As shown in FIG. 4, the first metal casing 54 and the second metal casing 56 may be welded to each other. That is, the first metal casing and the second metal casing may be joined to each other by welding without being crimped. This substantially means that the casing is not sealed by crimping but is sealed by welding instead. Since welding is performed instead of crimping, the first metal casing and the second metal casing substantially maintain the initial form. Thus, it is possible to improve the volume energy density of the secondary battery without increasing the width dimension of the casing by the amount that there is no deformation due to crimping and the like.

The welding may be performed from the outside of the first metal casing and the second metal casing. That is, welding may be performed from a side opposite to a side where the electrode assembly is located or present. Although welding means is not particularly limited, for example, means capable of performing local heating such as a laser may be used.

One of the first metal casing and the second metal casing may be a cup-shaped member, and the other of the first metal casing and the second metal casing may be a lid-like member. In such a case, only a peripheral edge portion of the lid-like member may be welded from the outside to join the metal casings to each other, and relatively simple sealing can be performed. The term “lid-like member” used herein means a member provided so as to cover the cup-shaped member (preferably, a member covering the cup-shaped member so as to extend over a side wall of the cup-shaped member). The lid-like member may be, for example, a single member (typically a flat plate-like member) extending in the same plane, and may be particularly a member provided so as to cover over the side wall of the cup-shaped member. In an exemplary embodiment shown in FIG. 4, the first metal casing 54 is the lid-like member, and the second metal casing 56 is the cup-shaped member. Even in such a form, as shown in FIG. 2, in each of the first metal casing 54 and the second metal casing 56, the first metal casing 54 and the second metal casing 56 can be combined with each other by welding without changing the width dimension thereof (particularly without changing the width dimension in part or locally).

Preferably, the lid-like member is a member placed on the side wall of the cup-shaped member. In particular, the peripheral edge portion of the lid-like member is a member positioned on the side wall of the cup-shaped member (more specifically, on an end portion of the side wall). Thus, when the first metal casing and the second metal casing are combined, the peripheral edge portion of the lid-like member is positioned on the side wall of the cup-shaped member. Thus, the lid-like member can be more stably disposed on the cup-shaped member. For example, in a sectional view as shown in FIG. 4, an outer peripheral edge of the lid-like member may be flush with an outer surface of the side wall of the cup-shaped member. When such a lid-like member and a cup-shaped member are used, not only side surface uniformity as the casing is improved, but also only the peripheral edge portion of the lid-like member can be welded and joined to the side wall of the cup-shaped member in a more stable state, and a more desirable joint state between the lid-like member and the cup-shaped member is easily obtained.

The present invention can be embodied in various manners. This will be described below.

(Secondary Battery being Circular in Planar View)

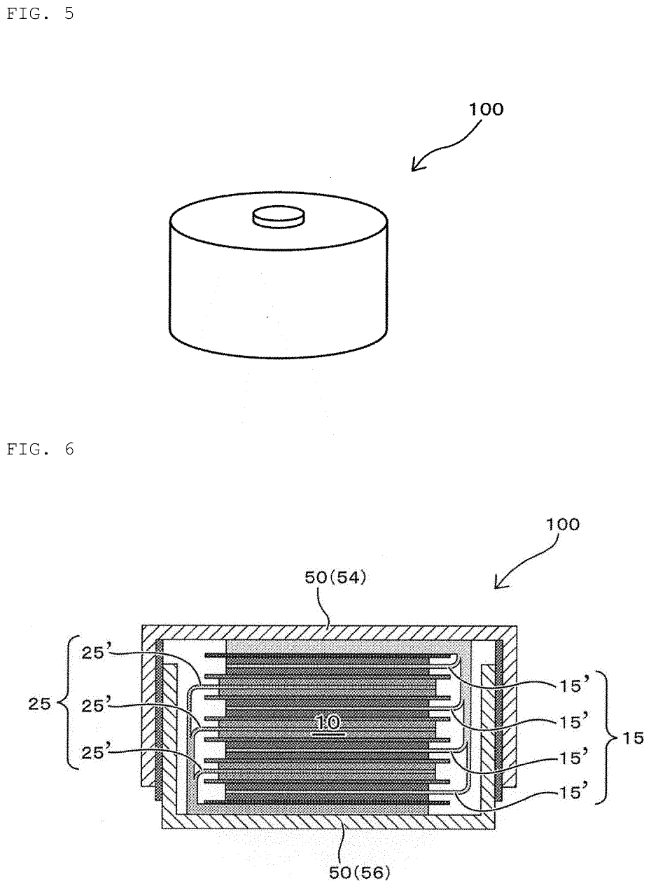

In this aspect, the shape of the secondary battery in planar view is circular. That is, the secondary battery 100 is of a button type or a coin type in terms of an outer shape (see FIG. 5).

The fact that the shape of the secondary battery in the planar view is circular means that the shape of the electrode assembly and/or the casing enclosing the electrode assembly is substantially circular when the electrode assembly is viewed from the upper side or the lower side along the stacking direction of the positive electrode and the negative electrode.

The term “circular shape (substantially circular shape)” as used herein is not limited to a perfect circular shape (that is, simply “circle” or “perfect circle”), and includes a shape that can be usually included in a “round shape” as recognized by those skilled in the art while being changed therefrom. For example, not only the circle and the perfect circle but also a shape in which a curvature of the circular arc is locally different may be adopted, and furthermore, a shape derived from the circle and the perfect circle such as an ellipse may be adopted. In a typical example, a battery having such a circular shape in planar view corresponds to a so-called button type or coin type battery.

In the present invention, there is no form in which the casing is “crimped” in the secondary battery having a circular shape in planar view. That is, the cup-shaped members constituting the casing or the cup-shaped member and the lid-like member are not crimped and combined. While a crimping configuration causes an increase in volume, since there is no crimping configuration in the present invention, a button-type or coin-type secondary battery suitable in terms of miniaturization and improvement in energy density is easily obtained.

(Folded Mode of Current Collection Tab Assembly)

The folded mode is a mode in which a current collection tab assembly in which current collection tabs extending from a plurality of electrodes of an electrode assembly are joined to each other is suitably used.

Specifically, the current collection tab assembly is formed by joining the current collection tabs, extending from at least one of a plurality of positive electrodes and a plurality of negative electrodes of the electrode assembly, to each other, the current collection tab assembly is bent and positioned on at least one of an upper surface and a lower surface of the electrode assembly, and the current collection tab assembly and the casing are connected to each other. As a result, the casing in contact with the current collection tab assembly can be provided as the electrode terminal, and a degree of freedom in designing the secondary battery is increased in terms of the external terminal.

This will be further described with reference to an exemplary embodiment of FIG. 6. While current collection tabs 15′ extending from the plurality of positive electrodes of the electrode assembly are joined to each other to constitute a current collection tab assembly 15 on the positive electrode side, the current collection tab assembly 15 is bent so as to be folded back toward the upper surface of the electrode assembly 10. The current collection tab assembly 15 folded back in this manner is positioned between the electrode assembly 10 and the casing 50, and is connected to the casing 50 (particularly, the first metal casing 54 corresponding to a sub-casing on an upper side thereof). Similarly, while current collection tabs 25′ extending from the plurality of negative electrodes of the electrode assembly are joined to each other to constitute a current collection tab assembly 25 on the negative electrode side, the current collection tab assembly 25 is bent so as to be folded back toward the lower surface of the electrode assembly 10. The current collection tab assembly 25 folded back in this manner is positioned between the electrode assembly 10 and the casing 50, and is connected to the casing 50 (particularly, the second metal casing 56 corresponding to a sub-casing on a lower side thereof). In this way, the first metal casing 54 corresponding to the upper side of the casing 50 can be provided as a positive electrode external terminal, and the second metal casing 56 corresponding to the lower side of the casing 50 can be provided as a negative electrode external terminal.

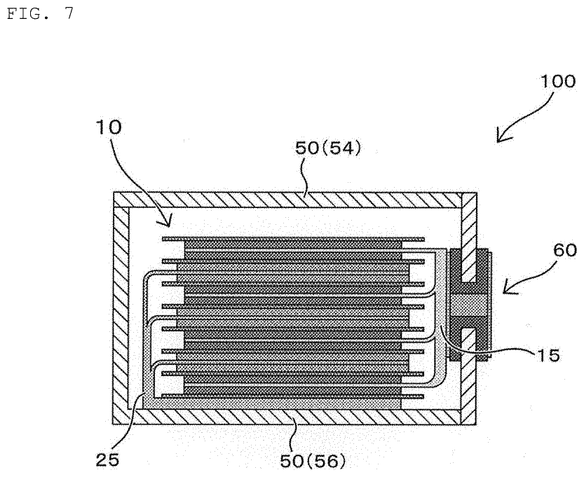

In another preferred aspect, the current collection tab assembly of one of the positive electrode and the negative electrode may be configured to be connected to the casing, and the current collection tab assembly of the other of the positive electrode and the negative electrode may be configured to be connected to an electrode terminal electrically separated from the casing by an insulating material. For example, as shown in FIG. 7, the current collection tab assembly 25 on the negative electrode side of the electrode assembly is bent so as to be folded back and positioned on a main surface of the electrode assembly to bring the current collection tab assembly 25 and the casing 50 into contact with each other, and the plurality of current collection tab assemblies 15 on the positive electrode side of the electrode assembly are connected to an external connection terminal 60 insulated from the casing 50. The external connection terminal may be made of, for example, a conductive rivet member, and therefore a conductive portion positioned on both the inside and the outside of the casing may be provided. As described above, when a casing portion is provided as the negative electrode, and the external connection terminal (the external connection terminal electrically insulated from the casing by insertion of the insulating material) provided in the casing is provided as the positive electrode, an area of the negative electrode can be larger than that of the positive electrode. Thus, if the electrode comes into contact with an interior of the casing as a lithium ion battery, a possibility of causing a large short circuit can be reduced.

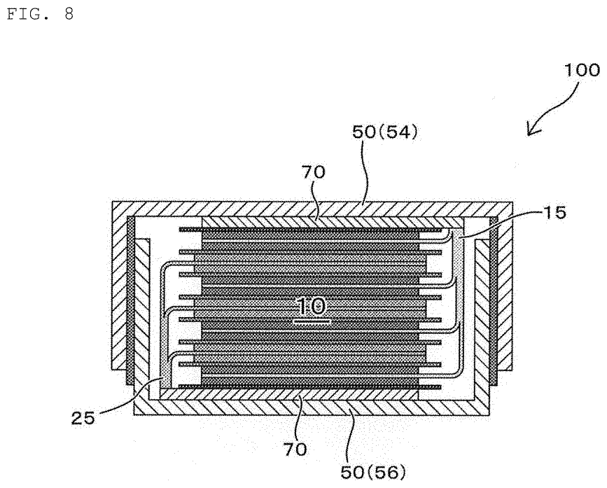

When the current collection tab assembly is used, a conductive member joined to the current collection tab assembly may be provided on at least one of the upper surface and the lower surface of the electrode assembly, and the current collection tab assembly and the casing may be brought into contact with each other with the conductive member interposed therebetween. That is, the current collection tab assembly and the casing may be electrically connected with the conductive member, provided on the upper surface and/or the lower surface of the electrode assembly, interposed therebetween. For example, as shown in FIG. 8, when a conductive member 70 connected to the current collection tab assembly 15 on the positive electrode side is disposed on the main surface of the electrode assembly 10, the conductive member 70 may be in contact with the casing 50 (particularly, the first metal casing 54 of the casing 50). Similarly, when the conductive member 70 connected to the current collection tab assembly 25 on the negative electrode side is disposed on the main surface of the electrode assembly 10, the conductive member 70 may be in contact with the casing 50 (particularly, the second metal casing 56 of the casing 50). The conductive member 70 may be provided on an insulating member forming an outermost layer of the electrode assembly 10, a separator, or the like. As described above, in the present invention, the conductive member joined to the current collection tab assembly may be positioned on both the upper surface and the lower surface of the electrode assembly, and the current collection tab assembly and the casing may be brought into contact with each other with the conductive member interposed therebetween.

The material of the conductive member 70 is not particularly limited as long as it exhibits “conductivity”, and may be, for example, a material containing at least one selected from the group consisting of copper, aluminum, stainless steel, nickel, and the like. The conductive member 70 may have, for example, a plate-like or sheet-like form, and thus may have a thin thickness. For example, the thickness of the conductive member 70 may be equal to the thickness of each layer (that is, a positive electrode material layer, a negative electrode material layer, a separator, and/or a current collector layer of a positive electrode/negative electrode, and the like) constituting the electrode assembly. Although it is merely an example, the thickness of the conductive member 70 may be the same as the thickness of the current collector. As can be seen from an aspect shown in FIG. 8, when the conductive member 70 is used, the conductive member 70 may be disposed with respect to an electrode outermost layer of the electrode assembly 10. The conductive member 70 thus configured may be, for example, a member having a wide surface similar to the main surface (that is, the upper surface or the lower surface) of the electrode assembly.

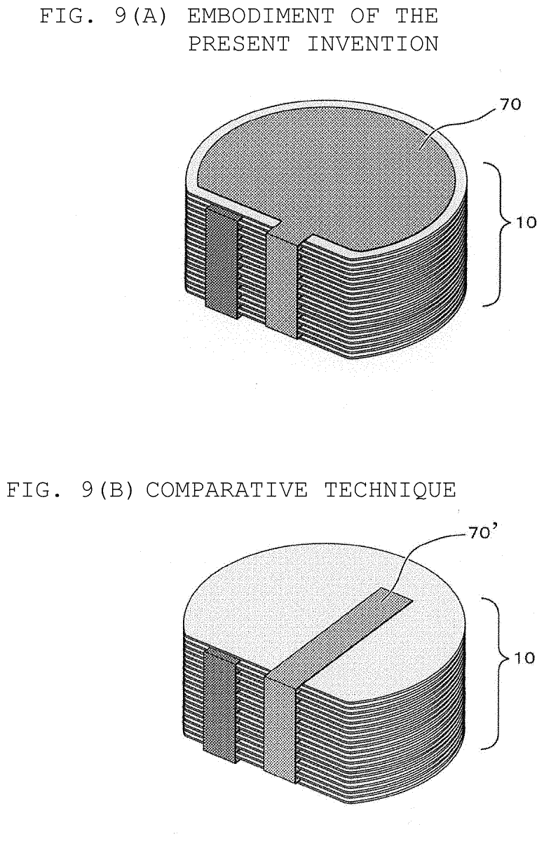

For example, a surface size of the conductive member is preferably close to the size of the main surface (that is, the upper surface and/or the lower surface) of the electrode assembly. More specifically, the conductive member preferably has a main surface size of the electrode included in the electrode assembly or another main surface size larger than the main surface size. That is, a planar view size (to put it briefly, an area of the shape of the conductive member in planar view) of the conductive member provided on the main surface of the electrode assembly is preferably equal to or more than the planar view size (in short, equal to or more than an area of the shape of each of the positive electrode and the negative electrode or one of the electrodes in planar view) of the electrode included in the electrode assembly. This is because the conductive member can more suitably act on an external force applied at the time of initial charge or the like in a battery manufacturing process. This will be described in detail with reference to the drawings. As shown in FIG. 9(B), for example, it is assumed that a current collector member 70′ disposed in an outermost layer of an electrode body has a belt-shaped current collection tab shape smaller than an electrode size. In such a case, the external force applied at the time of initial charge or the like during the battery manufacturing process is applied only to a position where the tab is present, which may lead to reaction non-uniformity of the battery. On the other hand, as shown in FIG. 9(A), when the main surface size of the current collector member (particularly, the conductive member 70 joined to the current collection tab assembly) is equal to or more than the electrode size according to the above aspect of the present invention, the external force applied during the manufacturing process is substantially uniformly applied to the electrode, so that an effect of easily obtaining more uniform reactivity can be provided.

The electrode assembly includes a separator. Although the conductive member is smaller than the main surface size of the separator, the conductive member may have a size equal to or more than the main surface size of the electrode (at least one of the positive electrode and the negative electrode) included in the electrode assembly. As a result, the conductive member can be suitably provided with more uniform reactivity as described above while being stably positioned in the electrode assembly.

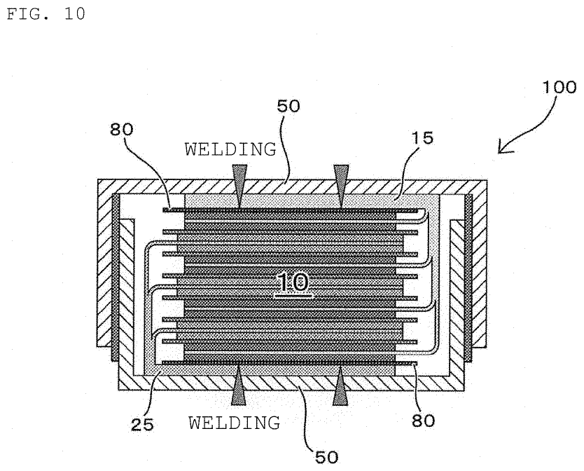

Even in an aspect in which the current collection tab assembly and/or the conductive member are/is used, welding may be used. For example, the current collection tab assembly and/or the conductive member and the casing may be welded to each other. Although FIG. 10 exemplifies the mode in which the current collection tab assemblies 15 and 25 are welded to the casing 50, the conductive member connected to the current collection tab assembly may be welded to the casing 50. Even in such a case, the welding treatment may be performed from the outside of the casing similarly to the welding between the metal casings. That is, welding may be performed from the side opposite to the side where the electrode assembly is located. Although the welding means is not particularly limited, means capable of performing local heating such as a laser may be used. When the current collection tab assembly and/or the conductive member and the casing are welded to each other as described above, it is possible to more suitably fix the current collection tab and/or reduce electric resistance. In addition, the manufacturing process can be simplified by performing welding from the outside of the casing.

As shown in FIG. 10, in the aspect in which welding is performed, an insulating member 80 may be provided in a region inside the casing 50. More specifically, the insulating member 80 may be disposed between the electrode assembly 10 and the current collection tab assemblies 15 and 25. The insulating member 80 thus configured not only prevents a short circuit in the secondary battery but also has an effect of reducing damage at the time of welding the current collection tab assembly and the casing. In view of such an effect, the insulating member 80 used in the present invention can also be referred to as an “insulating member for preventing short circuit/welding damage” or the like. The material of the insulating member is not particularly limited as long as the insulating member has the insulating properties, and the insulating member may be a member including a resin material (for example, a resin material which is conventionally used as the insulating material of the secondary battery).

(Aspect of Non-Opening of Cup-Shaped Member)

In such an aspect, the cup-shaped member has a non-opening form. More specifically, no opening is provided on a main surface of the cup-shaped member. In particular, no opening for an external connection terminal is provided on a surface of such a cup-shaped member.

For example, when both the first metal casing 54 and the second metal casing 56 are cup-shaped members (see FIG. 6), the opening for the external connection terminal is not provided on the main surface of the first metal casing 54, and the opening for the external connection terminal is not provided on the main surface of the second metal casing 56. That is, the opening for the external connection terminal is not provided on both the upper surface and the lower surface of the casing, which are not surfaces forming the side wall in the casing. When the first metal casing 54 is a lid-like member and the second metal casing 56 is a cup-shaped member (see FIG. 4), the opening for the external connection terminal is not provided on the main surface of the second metal casing 56 as the cup-shaped member. That is, the opening for the external connection terminal is not provided on one of the upper surface and the lower surface of the casing, which are not the surfaces forming the side wall in the casing.

As described above, since the opening is not provided on the main surface of the cup-shaped member, a structural strength of the cup-shaped member can be further improved (particularly, the structural strength can be improved as compared with the case where the opening is provided), and a more desirable casing can be easily provided.

In the casing 50 shown in FIG. 6, the opening for the external connection terminal is not provided; however, the folded current collection tab assembly 25 positioned between the electrode assembly 10 and the casing 50 is connected to the casing 50 (particularly, connected to each of the first metal casing 54 and the second metal casing 56 of the casing 50), and the casing itself of the first metal casing 54 and the second metal casing 56 forms the external connection terminal. In the casing shown in FIG. 4, the opening for the external connection terminal is provided in the first metal casing 54 as the lid-like member. The opening as described above is provided with the external connection terminal 60 formed of, for example, a rivet member, and an electrode current collection tab is connected to a portion of such a rivet member located inside the casing. That is, in such a case, the electrode current collection tab is connected to an external terminal member provided in the opening, and does not extend so as to pass through or insert through the opening.

[Secondary Battery of the Present Invention]

Next, the secondary battery of the present invention will be described. The secondary battery of the present invention corresponds to the battery obtained by the above-mentioned manufacturing method. Thus, the secondary battery of the present invention is characterized in the configuration of the casing enclosing the electrode assembly.

The secondary battery of the present invention includes the electrode assembly and the casing that houses the electrode assembly, and the casing has the two-part configuration including the first metal casing and the second metal casing. The first metal casing and the second metal casing as the metal members are joined to each other without being crimped. That is, the first metal casing and the second metal casing which are the metal members are not bent or recessed locally or in part in the sectional view due to non-crimping.

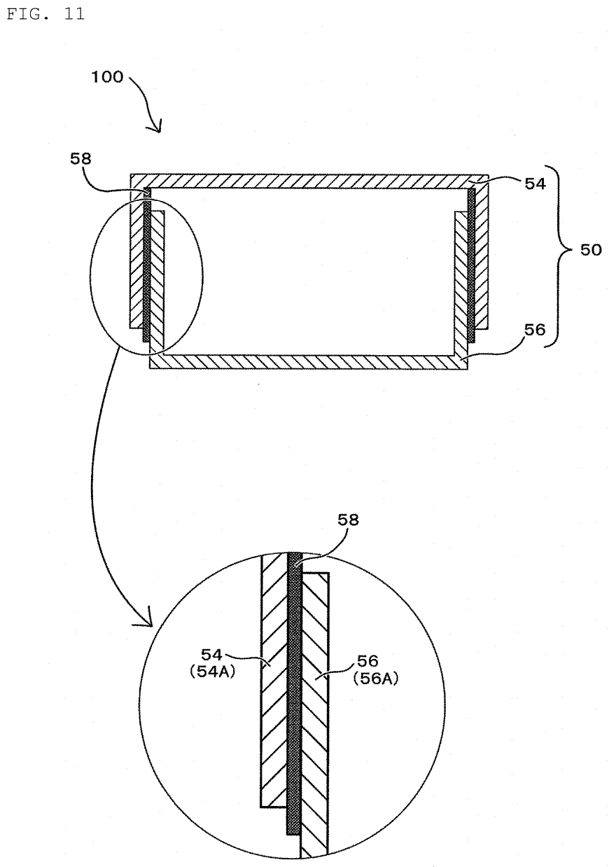

In a preferred aspect, as shown in FIG. 11, the first metal casing 54 and the second metal casing 56 are cup-shaped members, and all the side walls of the first metal casing 54 and the second metal casing 56 extend linearly in the sectional view. The side walls of both the first metal casing 54 and the second metal casing 56 preferably have a constant thickness in the sectional view.

In other words, as shown in FIG. 11, both the side walls 54A and 56A of the first metal casing 54 and the second metal casing 56 do not have bending or recesses, and both the side walls extend linearly in the sectional view. Since the casing is configured not to be crimped as described above, the width dimension of the casing does not increase due to the deformation of the casing, and thus, in the present invention, a secondary battery having an improved volume energy density is easily obtained.

In a preferred embodiment, an insulating bonding material is provided between the side wall of the first metal casing and the side wall of the second metal casing, and the insulating bonding material extends linearly in the sectional view. Preferably, the insulating bonding material extends linearly with a constant thickness in the sectional view (that is, in the sectional view, the insulating bonding material preferably extends linearly without changing the thickness thereof). Referring to FIG. 2, while the entire portion of the side wall 54A of the first metal casing 54 extends linearly, the entire portion of the side wall 56A of the second metal casing 56 also extends linearly, and the insulating bonding material 58 extending linearly in the sectional view is provided so as to be sandwiched between such linear side walls. As shown in the illustrated sectional view, the insulating bonding material may linearly extend along the side wall (in particular, the main surfaces of the side walls 54A and 56A) and parallel to the side wall without changing the thickness thereof. The form of such a linearly extending insulating bonding material is also caused by “non-crimping”, and thus can contribute to the improvement of the volume energy density of the secondary battery.

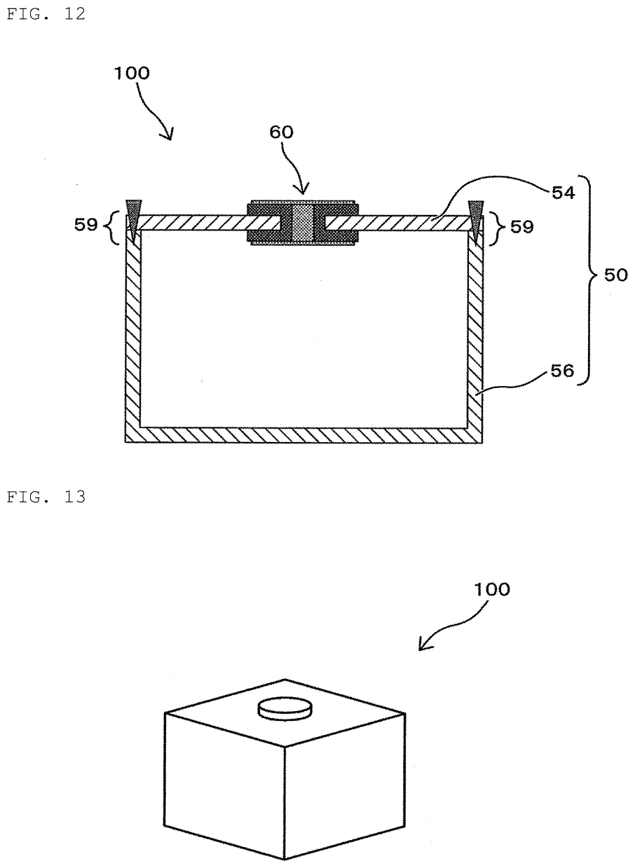

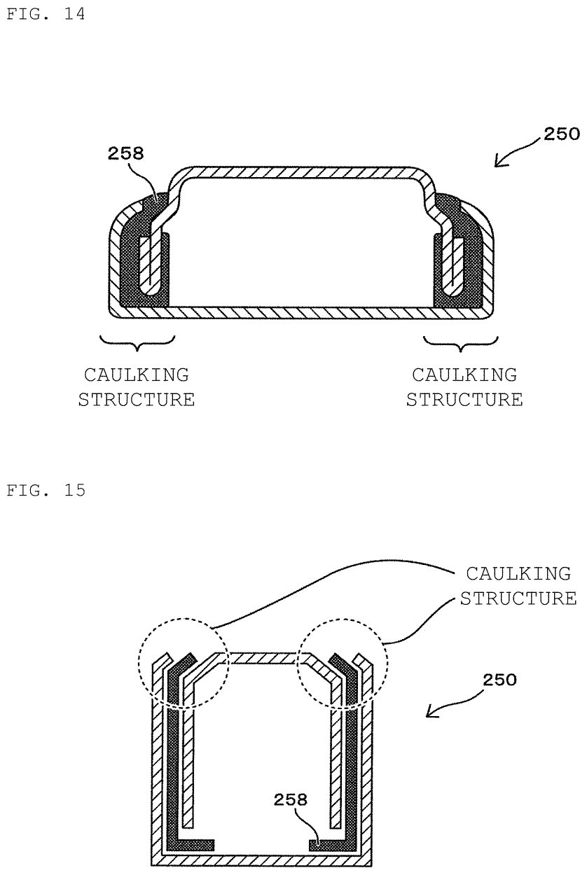

In another preferred aspect, the casing has a welded portion in which the first metal casing and the second metal casing are connected to each other. For example, as shown in FIG. 12, the first metal casing 54 is a lid-like member, the second metal casing 56 is a cup-shaped member, and the casing 50 has a welded portion 59 in which the first metal casing 54 and the second metal casing 56 are joined. More specifically, in the casing 50, the peripheral edge portion of the lid-like member is positioned on the side wall of the cup-shaped member, and the welded portion 59 that connects the peripheral edge portion of the lid-like member and a side wall upper portion of the cup-shaped member to each other is provided. As can be seen from the illustrated form, neither the first metal casing 54 nor the second metal casing 56 has a locally deformed portion, and thus the width dimension of the casing does not increase due to a combination of the sub-casings, and a secondary battery having an improved volume energy density is easily obtained.

In the aspect having the welded portion, the external connection terminal 60 insulated from the casing 50 may be provided in one of the first metal casing and the second metal casing. In the aspect shown in FIG. 12, the first metal casing 54 corresponding to the lid-like member may be provided with the external connection terminal 60 insulated from the first metal casing 54. As a result, the external connection terminal 60 can be provided as one electrode terminal of the positive electrode and the negative electrode, and the casing 50 can be provided as the other electrode terminal of the positive electrode and the negative electrode.

Other details such as further details and further specific aspects of the secondary battery of the present invention are described in [Features of manufacturing method of the present invention] mentioned above, and therefore the description thereof is omitted to avoid duplication.

Although the embodiments of the present invention have been described above, those are merely typical examples. Therefore, the present invention is not limited to those embodiments, and those skilled in the art will readily understand that various aspects can be conceived.

For example, in the above description, although the button-type or coin-type secondary battery has been mentioned as the “secondary battery being circular in planar view”, the present invention is not necessarily limited thereto. For example, a rectangular secondary battery may be used (see, for example, FIG. 13). That is, the shape of the secondary battery 100 in planar view is not limited to a circular shape, and the secondary battery 100 may have a quadrangular shape, a rectangular shape, or the like.

Although the drawings referred to above include the drawing on the assumption that the electrode assembly particularly has a planar stacking structure, the present invention is not necessarily limited to the electrode assembly having the planar stacking structure. That is, the present invention may be based on an electrode assembly having a winding structure as long as the electrode assembly is not a feature unique to the planar stacking structure, or may be based on an electrode assembly having a stack-and-folding-type structure.

The secondary battery according to the present invention can be used in various fields in which battery use or electricity storage is assumed. Although the followings are merely examples, the secondary battery of the present invention can be used in electricity, information and communication fields where electrical/electronic equipment and the like are used (e.g., electrical/electronic equipment fields or mobile device fields including mobile phones, smart phones, laptop computers, digital cameras, activity meters, arm computers, electronic papers, wearable devices, and small electronic devices such as RFID tags, card type electronic money, and smartwatches), domestic and small industrial applications (e.g., the fields such as electric tools, golf carts, domestic robots, caregiving robots, and industrial robots), large industrial applications (e.g., the fields such as forklifts, elevators, and harbor cranes), transportation system fields (e.g., the fields such as hybrid vehicles, electric vehicles, buses, trains, electric assisted bicycles, and two-wheeled electric vehicles), electric power system applications (e.g., the fields such as various power generation systems, load conditioners, smart grids, and home-installation type power storage systems), medical applications (medical equipment fields such as earphone hearing aids), pharmaceutical applications (the fields such as dose management systems), IoT fields, and space and deep sea applications (e.g., the fields such as spacecraft and research submarines).

### DESCRIPTION OF REFERENCE SYMBOLS

1: Positive electrode
15: Current collection tab assembly on positive electrode side
15′: Positive electrode current collection tab
2: Negative electrode
25: Current collection tab assembly on negative electrode side
25′: Negative electrode current collection tab
3: Separator
5: Electrode constituting layer
10: Electrode assembly
50: Casing
54: First metal casing
54A: Side wall of first metal casing
54B: Main surface portion/bottom portion of first metal casing
56: Second metal casing
56A: Side wall of second metal casing
56B: Main surface portion/bottom portion of second metal casing
58: Insulating bonding material
59: Welded portion
60: External output terminal
70: Conductive member
80: Insulating member
100: Secondary battery
250: Casing of conventional art
258: Insulating material used in casing of conventional art

1. A method of manufacturing a secondary battery, the method comprising:
combining a first metal casing and a second metal casing with each other without crimping so as to house an electrode assembly between the first metal casing and the second metal casing.

2. The method of manufacturing a secondary battery according to claim 1, wherein a side wall of the first metal casing and a side wall of the second metal casing face each other without a changing form thereof locally or in part during the combining of the first metal casing and the second metal casing.

3. The method of manufacturing a secondary battery according to claim 1, wherein the first metal casing and the second metal casing are combined with each other without locally changing width dimensions of both the first metal casing and the second metal casing.

4. The method of manufacturing a secondary battery according to claim 1, wherein a portion of the first metal casing and the second metal casing that is combined is not bent or recessed during the combining of the first metal casing and the second metal casing.

5. The method of manufacturing a secondary battery according to claim 4, wherein the portion of the first metal casing and the second metal casing that is combined is a side wall of each of the first metal casing and the second metal casing.

6. The method of manufacturing a secondary battery according to claim 1, further comprising disposing an insulating bonding material between a side wall of the first metal casing and a side wall of the second metal casing so as to join the first metal casing and the second metal casing to each other.

7. The method of manufacturing a secondary battery according to claim 6, wherein a form of the insulating bonding material is maintained without bending or recessing the insulating bonding material during the combining of the first metal casing and the second metal casing.

8. The method of manufacturing a secondary battery according to claim 1, wherein each of the first metal casing and the second metal casing is a cup-shaped member.

9. The method of manufacturing a secondary battery according to claim 1, wherein one of the first metal casing and the second metal casing is a cup-shaped member, and the other of the first metal casing and the second metal casing is a lid-like member.

10. The method of manufacturing a secondary battery according to claim 9, wherein a peripheral edge portion of the lid-like member is positioned on a side wall of the cup-shaped member during the combining of the first metal casing and the second metal casing.

11. The method of manufacturing a secondary battery according to claim 1, further comprising joining current collection tabs that extend from at least one of a plurality of positive electrodes and a plurality of negative electrodes of the electrode assembly to each other to form a current collection tab assembly; bending and positioning the current collection tab assembly on at least one of an upper surface and a lower surface of the electrode assembly; and connecting the current collection tab assembly and the casing to each other.

12. The method of manufacturing a secondary battery according to claim 11, further comprising joining a conductive member to the current collection tab assembly on at least one of the upper surface and the lower surface of the electrode assembly such that the current collection tab assembly and the casing are connected to each other with the conductive member interposed therebetween.

13. The method of manufacturing a secondary battery according to claim 12, wherein a planar view size of the conductive member is equal to or more than a planar view size of an electrode included in the electrode assembly.

14. The method of manufacturing a secondary battery according to claim 11, wherein the current collection tab assembly of one of the positive electrode and the negative electrode is connected to the casing; and the method further comprises connecting the current collection tab assembly of the other of the positive electrode and the negative electrode to an electrode terminal electrically separated from the casing by an insulating material.

15. The method of manufacturing a secondary battery according to claim 12, further comprising welding the casing and the current collection tab assembly and/or the conductive member to each other.

16. The method of manufacturing a secondary battery according to claim 1, wherein the electrode assembly includes a positive electrode and a negative electrode that are capable of inserting and extracting a lithium ion.

17. A secondary battery comprising:
an electrode assembly;
a first metal casing; and
a second metal casing,
wherein the first metal casing and the second metal casing are combined with each other without being crimped so as to house the electrode assembly between the first metal casing and the second metal casing.

18. The secondary battery according to claim 17, wherein side walls of both the first metal casing and the second metal casing are not bent or recessed, and the side walls extend linearly in a sectional view of the secondary battery.

19. The secondary battery according to claim 17, further comprising an insulating bonding material between a side wall of the first metal casing and a side wall of the second metal casing, the insulating bonding material extending linearly with a constant thickness in a sectional view of the secondary battery.

20. The secondary battery according to claim 17, wherein the casing has a welded portion where the first metal casing and the second metal casing are connected to each other.
